(19) United States
(12) Patent Application Publication
(10) Pub. No.: US 2007/0248707 A1
(43) Pub. Date: Oct. 25, 2007

(54) Tire mold molding a tire tread and pneumatic tire molded by the mold

(75) Inventor: Masaaki Ohara, Osaka-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: Toyo Tire & Rubber Co., Ltd., Osaka-shi (JP)

(21) Appl. No.: 11/788,932

(22) Filed: Apr. 23, 2007

(30) Foreign Application Priority Data
Apr. 24, 2006 (JP) 2006-119340

(51) Int. Cl. B29C 35/00

(52) U.S. Cl. 425/28.1; 425/47

(57) ABSTRACT

The present invention relates to a tire mold wherein segments 11 and 12 are provided with a plurality of pieces 21 to 25 and 31 to 35 divided in the tire circumferential direction, each of said pieces 21 to 25 and 31 to 35 are slidable in the tire circumferential direction, and among each of said pieces 21 to 25, pieces 31 to 35, repulsive means 70a and 70b are arranged in each of spaces between end surfaces in the tire circumferential direction of each of said pieces 21 to 25, and 31 to 35 except spaces between end surfaces in the tire circumferential direction on segment-end side of each of end pieces 21, 25, 31, and 35.

The description of this application claims benefit of priority based on Japanese Patent Application No. 2006-119340, the entire same contents of which are incorporated by reference herein.

### BACKGROUND OF THE INVENTION

1. Field of the Invention

The present invention relates to a tire mold in which a portion for molding a tread is divided into a plurality of segments and in more detail, the present invention relates to a technique for molding a tire with good uniformity inhibiting a rubber flash to spaces between adjacent segments.

2. Description of the Prior Art

In molding a pneumatic tire, a mold with sectors divided with a portion molding a tire tread divided in the tire circumferential direction has been used. The divided portion is called a segment and usually, a segment is divided into 7 to 13. At the time of molding, each segment moves inside of the radial direction to a tire rotational axis, then a mold is closed, and a tire is molded. For example, a tire mold is known as stated in Japanese Patent Laid-Open Publication No.2002-361632 (Patent document 1). A tire mold invented by the same inventor of the present application and stated in Japanese Patent Laid-Open Publication No.2006-21357 (Patent document 2) is also known.

In the mold of the Patent document 1, at the time of molding a tire, each segment moves to the tire radial direction. As illustrated in FIG. 1, when a segment 1a is provided with protrusions 2a and 2b that mold a transverse groove on a tread surface, the protrusion 2a at the center portion of the segment 1a proceeds into the tire radial direction Ra from a surface of a green tire T thereby molding the transverse groove.

However, angle deviation is generated in the mold of the Patent document 1, since the direction that the protrusion 2b at the end portion of the segment 1a proceeds from the surface of the green tire T is the same as the direction R a that the protrusion 2a proceeds, but not the direction R b that the protrusion 2 b extends. As a result, a rubber of the green tire T is pushed by the protrusion 2b from the center portion of the segment 1a toward the end portion of the segment 1a. Likewise, in an adjacent segment 1b, a protrusion 2d at the segment end portion proceeds into the direction of R c that is a different direction from the extending direction Rd. As a result, a rubber of the green tire T is pushed from the center portion of the segment 1b toward the end portion of the segment 1b by the protrusion 2d.

Therefore, the thickness of the portion sandwiched by the protrusions 2b and 2d of the green tire T increases. By the movement of the rubber, the portion with locally increased thickness is sandwiched by segments that are adjacent in the process of closing a mold, and as a result, the rubber flash is formed and the quality of appearance is degraded. In addition, due to the movement of the rubber, the thickness of the tread portion becomes non-uniform, which sometimes caused the deterioration of a tire property as well.

With a view to solving the above mentioned problem, in the mold of the Patent document 2, a segment is divided into a plurality of pieces thereby preparing a structure in which each piece is slidable. However, for the pieces to slide, spaces are required and the slide resistance of each piece varies. Further, depending on the degree to which the mold is exactly mounted and on the degree to which the vulcanizing apparatus is exactly adjusted, it was considered difficult that the mold should contract its diameter while each segment retains a perfect circle.

Theoretically, the amount of the rubber flash is uniform regardless of whether they are pieces at the both ends of a segment or whether they are pieces at the center portion of the segment. However, when I observed the tire vulcanized by the mold of the Patent document 2, I noticed that the rubber flash in a piece at the both ends of a segment tended to be larger than pieces at other places. Therefore, from the view point of uniformizing the thickness of the tread rubber inhibiting the rubber from protruding, it was not satisfactory only by the technique of the Patent document 2. In addition, there were possibilities that the piece at the both ends of each segment might fall off.

The object of the present invention is to provide a mold capable of inhibiting the rubber flash at the time of molding and of molding a tire with good uniformity, further intending to prevent the fall off of the divided pieces by dividing a segment that molds a tread into pieces.

### SUMMARY OF THE INVENTION

In order to solve the above mentioned problem, as a result of intensive studies, the present invention relates to a tire mold molding a tire tread, comprising a plurality of segments dividing the tire mold in the tire circumferential direction wherein said segments are provided with a plurality of pieces dividing said segments in the tire circumferential direction, and each of said pieces is slidable in the tire circumferential direction, and one or more repulsive means arranged in each of spaces between end surfaces in the tire circumferential direction of each said pieces, except each of spaces between end surfaces in the tire circumferential direction on segment-end side of end pieces, that are the pieces arranged on both ends in the tire circumferential direction of each said segment.

The each of spaces between the pieces is gradually narrowed by the repulsive means. As a result, the air in the mold can be exhausted and also the rubber flash can be inhibited.

Further, since one or more repulsive means arranged in each of spaces between the end surfaces in the tire circumferential direction of said each piece (except spaces between end surfaces in the tire circumferential direction on segment-end side of end pieces), in the contraction of the diameter of the mold, firstly, the end pieces contact each other at the end surfaces in the tire circumferential direction on the segment-end side, and then, by the contraction of the repulsive means, the adjacent pieces contact each other at the end surfaces in the tire circumferential direction (except said end pieces on said segment-end side).

Therefore, each piece moves along with the direction that is closer to the radial direction towards which each piece goes to the point equivalent to the tire rotational axis, thereby proceeding to the green tire. In particular, the above-mentioned end pieces that used to move to the direction that is greatly deviated from the radial direction in the conventional mold, moves to the direction that is closer to the radial direction and proceed into the green tire. As a result, the rubber protruding between pieces can be inhibited.

The present invention also relates to the invention of the tire mold wherein each of said pieces is provided with one or more recessed portions on both of the end surfaces in the tire circumferential direction, except on the end surface in the tire circumferential direction on segment-end side of each of said end pieces, and said repulsive means is arranged bridging over each of said recessed portions of the adjacent pieces.

When a coil spring is selected as a repulsive means, for example, even though the recessed portion is provided on one of the end surfaces in the tire circumferential direction of the piece, the coil spring can be inserted in said recessed portion. In this case, the end portions of the coil spring not inserted in the recessed portion contact the end surfaces of the opposite piece. However, in such an embodiment, whenever the mold contracts its diameter, the contact positions on the piece end surfaces become different. Further, when the coil spring has buckled, the direction of the repulsion of the coil spring deviates from the sliding direction of the piece, thereby causing sliding interruption of the piece.

In this regard, as in the present invention, the buckling of the coil spring can be inhibited and the sliding interruption of the piece can also be inhibited, since each of the pieces is provided with one or more recessed portions on both of the end surfaces, and said repulsive means is arranged bridging over each of said recessed portions of the adjacent pieces. Further, by providing a plurality of recessed portions on one end surface and by arranging a repulsive means over each of said recessed portions, the direction and the magnitude of the repulsive force can be uniformized over the whole area of the end surfaces of the piece, which can inhibit the sliding interruption caused by the inclination of the piece in the segment.

The present invention also relates to the invention of the tire mold, wherein stoppers and recessed portions into which said stoppers can proceed are provided, said stoppers are provided on both end surfaces in the tire circumferential direction of said segments and each of said stoppers protrudes to said end piece side from a sliding surface with each of sliding surfaces of said segments and said end pieces, said recessed portions are provided on the end surfaces in the tire circumferential direction on the segment-end side of said end pieces.

On both end surfaces in the tire circumferential direction of said segment, a stopper is provided that protrudes to the end piece side from the sliding surface between the segment and the end piece, and the recessed portion into which said stopper can proceed is provided on the end surfaces in the tire circumferential direction in the segment end of said each end piece. As a result, even when the end piece moves in the tire circumferential direction, since the stopper contacts the bottom of the recessed portion of the end piece, falling off of the piece from the segment can be prevented.

### BRIEF DESCRIPTION OF THE DRAWINGS

FIG. 1 is a view illustrating a tire mold according to the prior art;

FIG. 2 is a view illustrating a condition when the tire mold is closed according to the present invention;

FIG. 3 is a view illustrating a section of the tire mold according to the present invention;

FIG. 4 is a view illustrating a section showing the vicinity of a stopper when the mold is closed.

FIG. 5 is a view illustrating a section showing the vicinity of a stopper when the mold is opened.

FIG. 6 is a view illustrating a part of a segment when the mold is opened.

FIG. 7 is a view illustrating a part of a segment in the diameter contraction process of the mold.

FIG. 8 is a view illustrating a section showing a space between pieces.

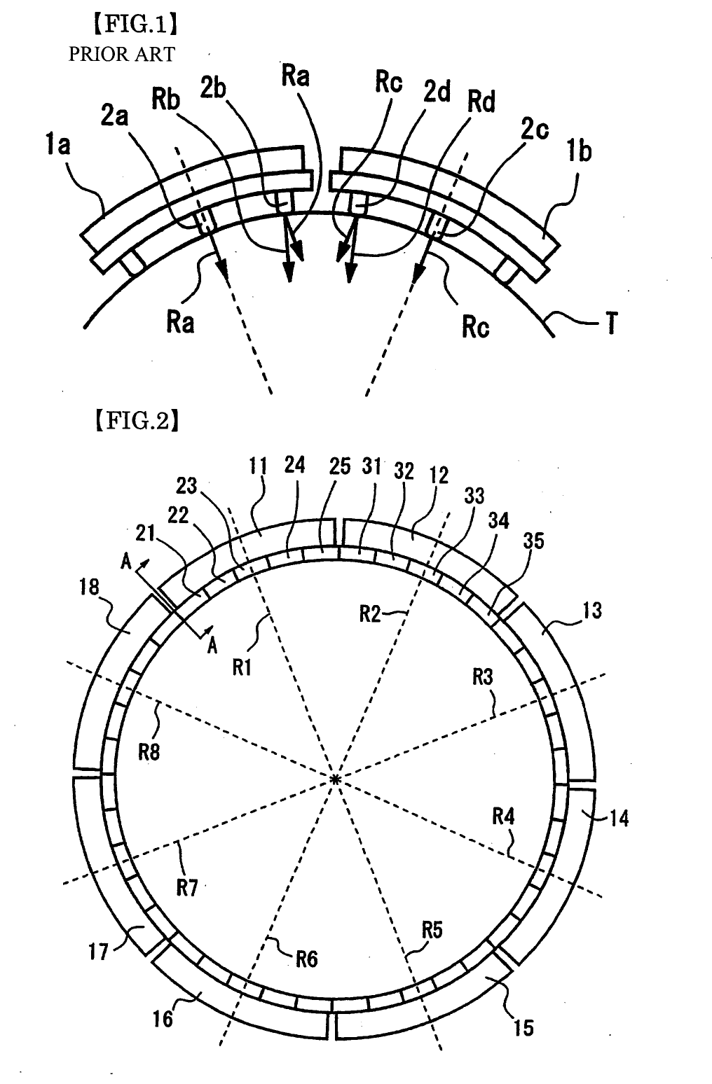

### DESCRIPTION OF THE PREFERRED EMBODIMENTS

An embodiment of a tire mold according to the present invention will now be explained on the basis of the drawings. FIG. 2 illustrates a condition in which the mold according to the present invention is closed. A tire mold molding a tire tread is divided into eight segments 11 to 18, and is movable in tire radial directions R1 to R8 in accordance with the diameter contraction. For instance, the segment 11 is movable in a tire radial direction R1.

Each segment comprises a plurality of pieces further divided in a tire circumferential direction. For example, the segment 11 is provided with pieces 21 to 25, and the segment 12 is provided with pieces 31 to 35. The piece 21 and others is provided with projections (not illustrated) for forming grooves on a tread surface. Among pieces 21 to 25 and 31 to 35, the end piece arranged on both ends in the tire circumferential direction of a segment are pieces 21, 25, 31, and 35 in the drawings.

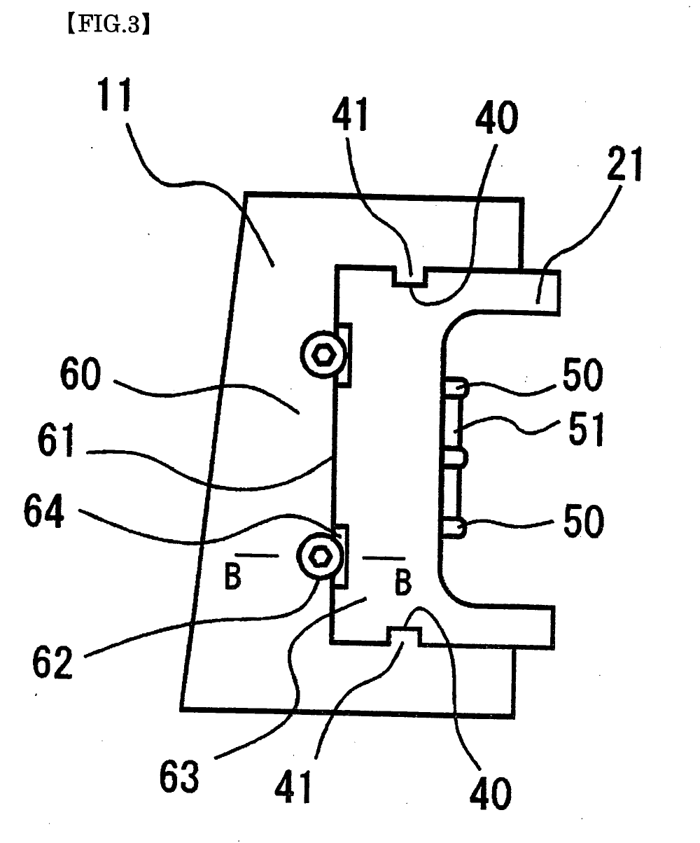

FIG. 3 is a sectional view along line A-A in FIG. 2. To take the piece 21 of segment 11 as an example, a groove 40 is formed thereon and since segment 11 is provided with a protrusion 41 and since the groove 40 is fitted with protrusion 41, the piece 21 is slidable in the tire circumferential direction. The same applies to other pieces 22 to 25. In addition, the piece 21 and others are provided with a protrusion 50 that molds the groove in the circumferential direction of the tread surface and a protrusion 51 that molds a transverse groove.

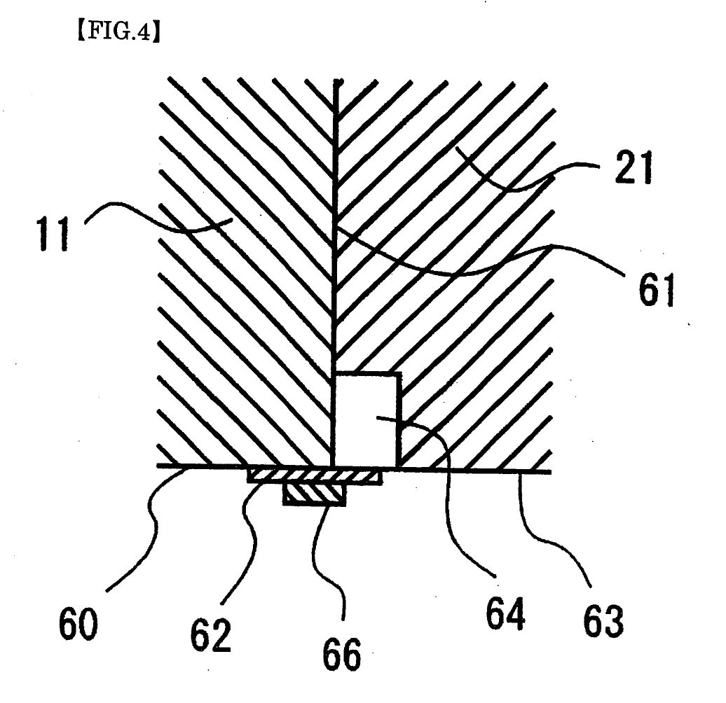

FIG. 4 is a sectional view along line B-B in FIG. 3 when the mold is closed. On an end surface 60 in the tire circumferential direction of the segment 11, a stopper 62 that protrudes from the sliding surface 61 between the segment 11 and the end piece 21 to the end piece side is provided. Further, in the end piece 21, on the end surface 63 in the tire circumferential direction in the end side of the segment 11, the recessed portion 64 into which the stopper 62 can proceed is provided on the end surface 63 in the tire circumferential direction in the end side of the segment 11.

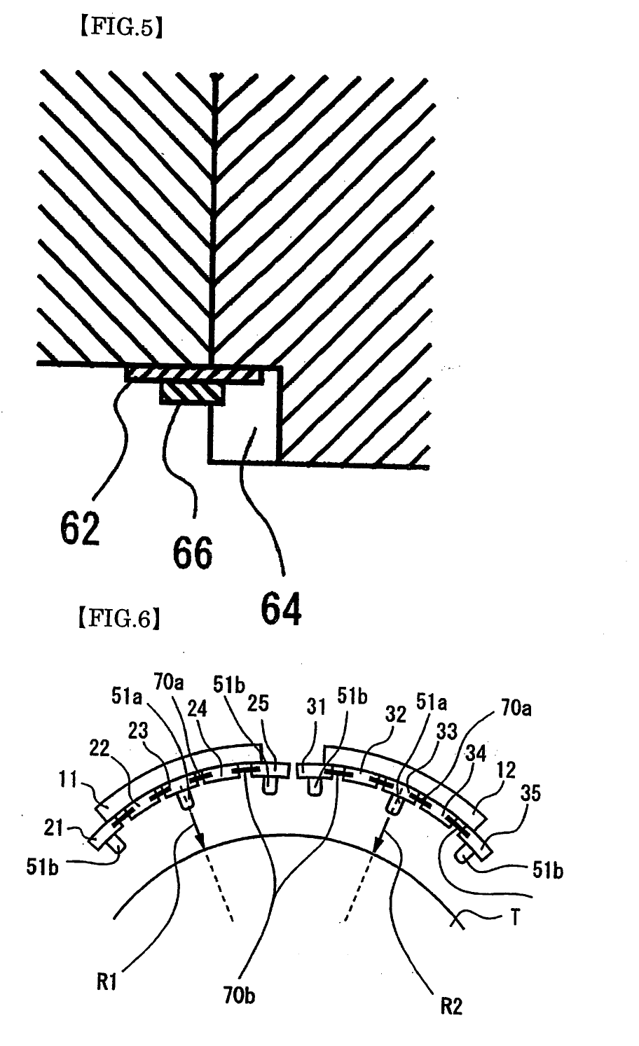

Therefore, as illustrated in FIG. 5 that is a sectional view along line B-B when the mold is closed, even when the end piece 21 slides as the space between pieces is widened, falling off of the end piece 21 from the segment 11 can be prevented, since the stopper 62 contacts the bottom portion of the recessed portion 64 of the end piece 21. For information, in attaching the stopper 62 and the nut 66, the space between segments 11 and 12 can be utilized when the mold is closed or the recessed portion (not illustrated) in which the stopper 62 and the nut 66 can be contained on the end surface 60 of the segment 11 can be provided.

The explanation goes on for the movement of the mold at the time of molding. FIG. 6 is a view when the mold is opened and only segments 11 and 12 are shown. In molding a tire, the segment 11 and the segment 12 move in the directions of R1 and R2 that are the radial directions of a tire respectively and the mold contracts its diameter. The pieces 23 and 33 at the center portion of the segments 11 and 12 and the end pieces 21, 25, 31, and 35 are provided with the protrusions 51 that mold a transverse groove. Coil springs 70a and 70b are arranged in the space between pieces 21 to 25 and 31 to 35 except the space between the end pieces 25 and 31 that are adjacent in segments 11 and 12. In an opened state of the mold, it is attached so that the space is widened between each of the pieces by the repulsive force of the coil springs 70a and 70b. However, when the space between pieces is widened, since end pieces 21, 25, 31, and 35 contact the stopper (not illustrated in FIG. 6), they are fixed on the specified positions without widening any longer. Therefore, each of the pieces 21 to 25 in one segment 11 is fixed on the specified position with substantially the same spaces (the same applies to pieces 31 to 35) by coil springs 70a and 70b (repulsive means) and by stoppers. It is preferable that the space between pieces in the segment when the mold is opened is 0.3 mm to 10 mm.

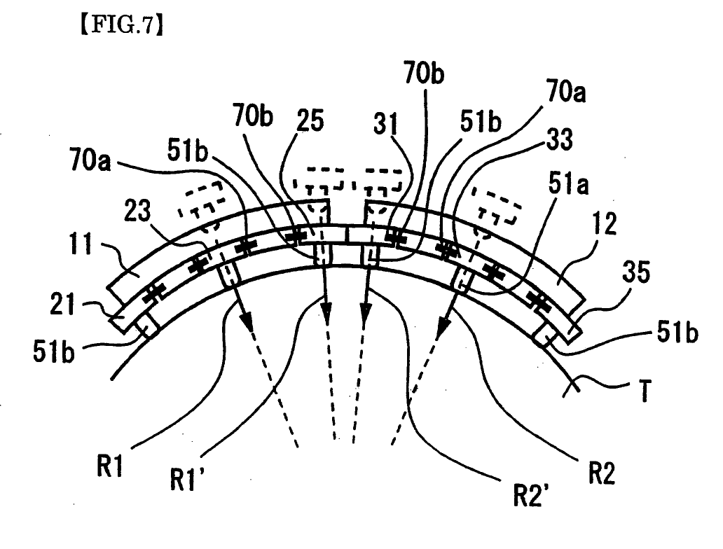

When the mold contracts its diameter, as shown in FIG. 7, segments 11 and 12 move to the directions of R1 and R2. In the contraction of the diameter of the mold, firstly, each of the end pieces 25 and 31 contact each other at the end surfaces in the tire circumferential direction on the segment-end sides 11 and 12, respectively, since the coil springs 70 a and 70 b are arranged in each of spaces between end surfaces in the tire circumferential direction of each said pieces, except spaces between end surfaces of end pieces 25 and 31.

Then the adjacent pieces contact each other in the tire circumferential direction (except the end pieces 25 and 31 on said side at the end surfaces), as the coil springs 70 a and 70 b shrink.

At the same time, the segments 11 and 12 move and the protrusion 51 a provided on each of the pieces also proceeds into a tire T in the directions of R1 and R2. As a result, a transverse groove is formed on a tread surface. And since the space between pieces is gradually narrowed by the coil springs 70a and 70b arranged in the space between pieces, the air in the mold can be exhausted and also the rubber flash can be inhibited.

In particular, each of the pieces 21 to 25 and 31 to 35 move along the direction closer to the radial direction towards the point equivalent to the tire rotational axis, thereby proceeding to the green tire. In particular, end pieces 25 and 31 arranged on both segment ends that used to move to the direction that is greatly deviated from the radial direction to the directions R1 and R2 in the conventional mold, moves to the directions R1 and R2 that are closer to the radial direction, thereby proceeding to the green tire. As a result, the rubber flash between the pieces can be inhibited.

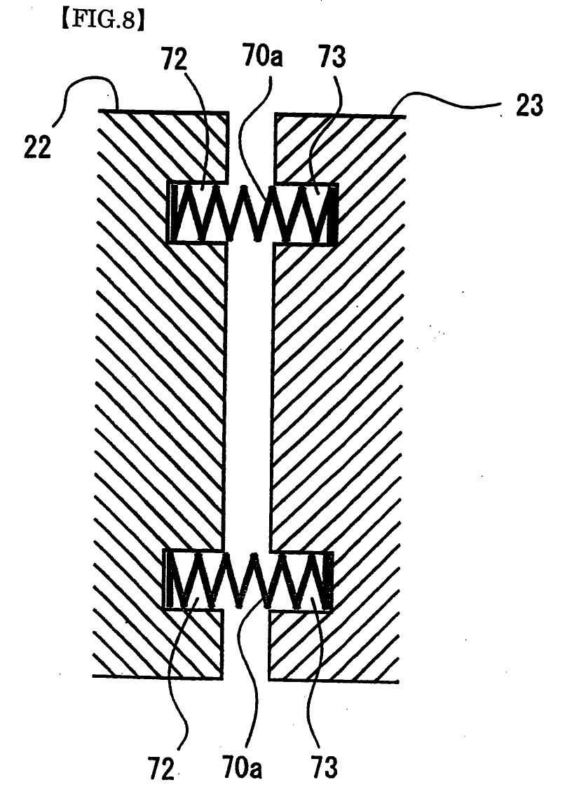

FIG. 8 is a sectional view showing a space between pieces 22 and 23. On the end surfaces in the tire circumferential direction of the opposite pieces 22 and 23, the recessed portions 72 and 73 are provided respectively, and in the recessed portions 72 and 73, the both ends of the coil spring 70a are inserted in a way that the both ends of the coil spring 70a are bridged over the both recessed portions. Therefore, the contact position of the coil spring 70a on the end surfaces of the piece does not change whenever the mold contracts its diameter, and no buckling occurs to the coil spring 70a.

As a result, the buckling of the coil spring 70a can be inhibited and the sliding interruption of the piece can be inhibited. In addition, since a plurality of coil springs 70a are arranged, the direction and magnitude of the repulsive force can be uniformized over the whole area of the end surfaces of the piece, which can inhibit the sliding interruption caused by the inclination of the piece in the segment. Further, the falling off of a coil spring 70a can be prevented by the recessed portions 72 and 73, by using the above mentioned stopped together, the effect of preventing falling off can be enhanced.

1. A tire mold for molding a tire tread, comprising a plurality of segments dividing the tire mold in a tire circumferential direction, wherein
said segments are provided with a plurality of pieces dividing said segments in the tire circumferential direction,
and each of said pieces is slidable in the tire circumferential direction,
and one or more repulsive means arranged in each of spaces between end surfaces in the tire circumferential direction of each said pieces
except each of spaces between end surfaces in the tire circumferential direction on segment-end side of end pieces, that are pieces arranged on both ends in the tire circumferential direction of each said segment.

2. The tire mold as set forth in claim 1, wherein each of said pieces is provided with one or more recessed portions on both of the end surfaces in the tire circumferential direction
except on the end surface in the tire circumferential direction on segment-end side of each of said end pieces,
and said repulsive means is arranged bridging over each of said recessed portions of the adjacent pieces.

3. The tire mold as set forth in claim 1, wherein stoppers and recessed portions into which said stoppers can proceed are provided,
said stoppers are provided on both end surfaces in the tire circumferential direction of said segments
and each of said stoppers protrudes to said end piece side from a sliding surface, with each of sliding surfaces of said segments and said end pieces,
said recessed portions are provided on the end surface in the tire circumferential direction on the segment-end side of each of said end pieces.

4. A tire mold for molding a tire tread, comprising a plurality of segments dividing the tire mold in a tire circumferential direction, wherein
said segments are provided with a plurality of pieces dividing said segments in the tire circumferential direction,
and each of said pieces is slidable in the tire circumferential direction,
stoppers and recessed portions into which said stoppers can proceed are provided,
said stoppers are provided on both end surfaces in the tire circumferential direction of said segments
and protrude to end piece sides from a sliding surface,
with the sliding surface of said segments and end pieces, said recessed portions are provided on an end surface in the tire circumferential direction on a segment-end side of each said end pieces.

5. A tire mold wherein
in a contraction of a diameter of the mold,
firstly, end pieces of adjacent segments contact each other at end surfaces in a tire circumferential direction on a segment-end side,
with said end pieces arranged on both ends in the tire circumferential direction of said segments,
and then adjacent end pieces contact each other at end surfaces in the tire circumferential direction, except said end pieces on a segment-end side.

6. A pneumatic tire molded by a tire mold set forth in claim 1.

7. A pneumatic tire molded by a tire mold set forth in claim 4.

8. A pneumatic tire molded by a tire mold set forth in claim 5.
